(19) United States
(12) Patent Application Publication
(10) Pub. No.: US 2014/0283798 A1
(43) Pub. Date: Sep. 25, 2014

(54) EXHAUST GAS RECIRCULATION DEVICE

(71) Applicant: DENSO CORPORATION, Kariya-city (JP)

(72) Inventor: Osamu SHIMANE, Kariya-city (JP)

(73) Assignee: DENSO CORPORATION, Kariya-city (JP)

(21) Appl. No.: 14/152,245

(22) Filed: Jan. 10, 2014

(30) Foreign Application Priority Data
Mar. 19, 2013 (JP) 2013-56478

(51) Int. Cl. F02M 25/07

(52) U.S. Cl. CPC F02M 25/0738
USPC 123/568.12

(57) ABSTRACT

An EGR passage recirculates a part of exhaust gas from an exhaust passage to an intake passage. An EGR valve opens and closes the EGR passage. An exhaust cooling passage includes an EGR cooler closer to the exhaust passage than the EGR valve. A bypass passage branches at an upstream of the exhaust cooling passage to bypass the EGR cooler and to extend toward a downstream of the exhaust cooling passage. In a bypass open mode, a bypass switching valve opens both the exhaust cooling passage and the bypass passage. In a bypass close mode, the bypass switching valve opens the exhaust cooling passage and closes the bypass passage. In a cooler close mode, the bypass switching valve closes the exhaust cooling passage and opens the bypass passage. The bypass switching valve is set at the bypass open mode when the EGR valve is closed.

### CROSS REFERENCE TO RELATED APPLICATION

This application is based on reference Japanese Patent Application No. 2013-56478 filed on Mar. 19, 2013, the disclosure of which is incorporated herein by reference.

### TECHNICAL FIELD

The present disclosure relates to an exhaust gas recirculation device configured to recirculate a part of exhaust gas of an internal combustion engine as EGR gas to an intake passage. For example, the present disclosure may relate to an exhaust gas recirculation device for an internal combustion engine, such as a diesel engine, and the exhaust gas recirculation device may include an EGR cooler to cool EGR gas and a bypass valve to open and close a bypass passage to control a bypass quantity of the EGR cooler.

### BACKGROUND

FIG. 4 shows a first example of EGR system (exhaust gas recirculation device) for an internal combustion engine) to recirculate EGR gas, which is a part of exhaust gas of an internal combustion engine, such as a diesel engine. In the EGR system, for example, EGR gas is recirculated from an exhaust passage 101 through an exhaust gas recirculation passage (EGR passage) 102 to an intake passage 103. In the EGR system, EGR gas may be cooled at an intermediate portion of the EGR passage 102, thereby to enhance a charging efficiency of EGR gas and to decelerate combustion in the engine. Thus, the present configuration may effectively reduce emission of nitrogen oxide (NOx). In the present configuration, a water-cooled EGR cooler 104 is provided to an intermediate portion of the EGR passage 102.

When the engine is in operation, an exhaust valve operates to open and close. The operation of the exhaust valve may cause a pressure pulsation of exhaust gas (pressure wave of exhaust pulsation). When pressure pulsation occurs in exhaust gas, and when the operation of an EGR valve 105 stops, that is, when the EGR valve 105 is a full close state, the pressure pulsation propagates through the exhaust passage 101 of the engine to cause exhaust gas to move into the EGR cooler 104 and to move out from the EGR system. In such a condition, exhaust gas is cooled by the EGR cooler 104, and moisture contained in the EGR gas condenses to generate condensate water. In particular, when water temperature is low, a large quantity of condensate water is generated in the EGR cooler 104.

When leakage occurs in the EGR valve 105 and/or when the EGR valve 105 is activated to open, condensate water generated in the EGR cooler 104 may flow toward the intake passage. Consequently, the condensate water may cause icing in a valve of the intake air system, such as the throttle valve. When a large quantity of condensate water flows into the cylinders of the engine, an engine combustion state may be impaired, and misfire may occur in the engine. When condensate water generated in the EGR cooler 104 and accumulated in the EGR passage 102 contains a strong acid component, the strong acid component may cause corrosion in the EGR cooler 104 and/or the EGR passage 102 after the strong acid component repeatedly becomes wet and dry. Consequently, the strong acid component may cause a serious defect such as perforation.

FIG. 5 shows a second example of an EGR system including an exhaust gas cooling passage 106, a bypass passage 107, and a bypass switching valve 108. The exhaust gas cooling passage 106 cools EGR gas, which flows from the EGR passage 102 into the EGR cooler 104. The bypass passage 107 branches flow of EGR gas, which flows toward the EGR passage 102, on the upstream side of the exhaust gas cooling passage 106 and conducts the EGR gas to the downstream side of the exhaust gas cooling passage 106 by bypassing the EGR cooler 104. The bypass switching valve 108 is located at a merge portion at which the exhaust gas cooling passage 106 merges with the bypass passage 107. The bypass switching valve 108 switches between a cool EGR gas mode and a hot EGR gas mode. In the cool EGR gas mode, the bypass switching valve 108 opens the exhaust gas cooling passage 106 and closes the bypass passage 107. In the hot EGR gas mode, the bypass switching valve 108 closes the exhaust gas cooling passage 106 and opens the bypass passage 107. Similarly to the EGR system of FIG. 4, the EGR system of FIG. 5 may generate condensate water in both the cooled EGR gas mode and the hot EGR gas mode due to exhaust gas moving into the EGR cooler 104 and moving out of the EGR cooler 104, which is caused by pressure pulsation (pressure wave of exhaust pulsation) of exhaust gas.

In consideration of this, in order to restrict the EGR passage including the EGR cooler from generating condensate water, for example, Patent Document 1 discloses an EGR system equipped with a return passage and a check valve. The return passage is connected with a passage between the EGR cooler and the EGR valve at an upstream end. The return passage is further connected with a passage, which is on the side of the exhaust passage relative to the EGR cooler at a downstream end. The check valve is equipped to the return passage and configured to regulate flow EGR gas selectively to one way from the upstream end toward the downstream end. The EGR system utilizes exhaust pulsation to recirculate condensate water, which is on the downstream side of the EGR cooler, toward the exhaust passage, when, for example, water temperature is less than or equal to 60 degrees Celsius during the engine is warmed up, and when the EGR valve is in a full close state.

It is noted that, in the conventional EGR system, pressure on the downstream side of the EGR cooler is low on average, due to pressure loss caused in the EGR cooler. Therefore, the check valve seldom opens. Consequently, condensate water on the downstream side of the EGR cooler cannot be efficiently discharged.

(Patent Document 1)

Publication of Unexamined Japanese Patent Application No. 2012-163082

### SUMMARY

It is an object of the present disclosure to produce an exhaust gas recirculation device configured to restrict generation of water in an EGR cooler and to avoid corrosion of the EGR cooler.

According to an aspect of the present disclosure, an exhaust gas recirculation device comprises an exhaust gas recirculation passage configured to recirculate a part of exhaust gas from an exhaust passage of an internal combustion engine to an intake passage of the internal combustion engine. The exhaust gas recirculation device further comprises an EGR valve configured to control an opening of the exhaust gas recirculation passage. The exhaust gas recirculation device further comprises an exhaust gas cooling passage including an EGR cooler, which is closer to the exhaust passage than the EGR valve. The exhaust gas recirculation device further comprises a bypass passage configured to branch a flow of exhaust gas, which passes through the exhaust gas recirculation passage, at an upstream of the exhaust gas cooling passage and to bypass the EGR cooler and to conduct the flow of exhaust gas toward a downstream of the exhaust gas cooling passage. The exhaust gas recirculation device further comprises a bypass switching valve located at a merge portion between the exhaust gas cooling passage and the bypass passage or located at the bypass passage. The bypass switching valve configured to switch among a bypass open mode to open both the exhaust gas cooling passage and the bypass passage, a bypass close mode to open the exhaust gas cooling passage and to close the bypass passage, and a cooler close mode to close the exhaust gas cooling passage and to open the bypass passage. The bypass switching valve is configured to be set at the bypass open mode when the EGR valve is in a full close state.

### BRIEF DESCRIPTION OF THE DRAWINGS

The above and other objects, features and advantages of the present invention will become more apparent from the following detailed description made with reference to the accompanying drawings. In the drawings:

FIG. 1 is a view showing an EGR system in a bypass open mode;

FIG. 2 is a view showing an EGR system in a bypass close mode;

FIG. 3 is a view showing an EGR system in a cooler close mode;

FIG. 4 is a view showing an EGR system according to a first example; and

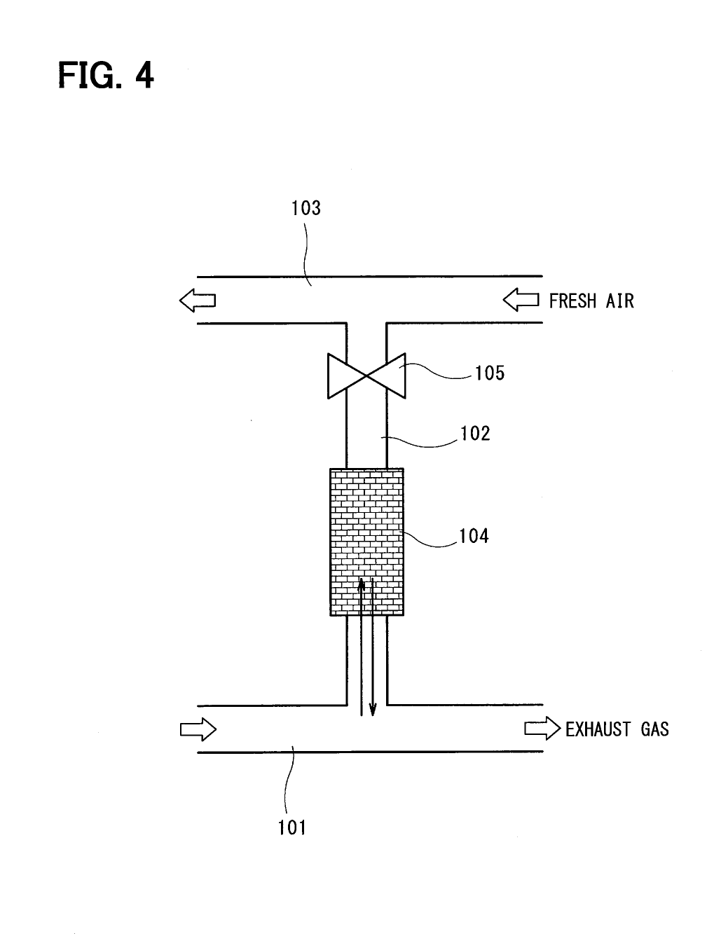

FIG. 5 is a view showing an EGR system according to a second example.

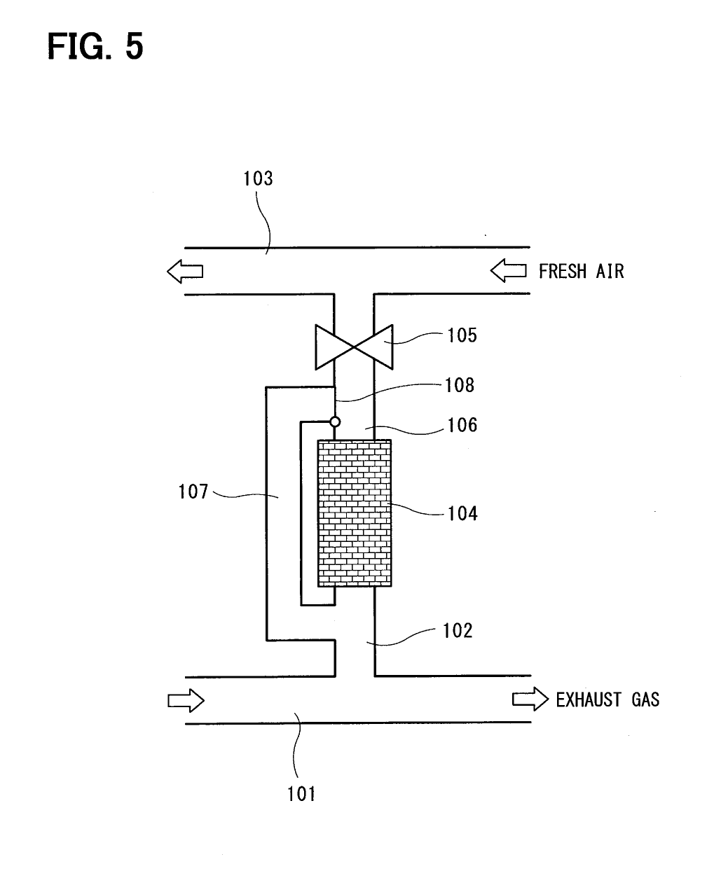

### DETAILED DESCRIPTION

As follows, embodiments according to the present disclosure will be described in detail with reference to drawings.

### Embodiment

### Configuration of First Embodiment

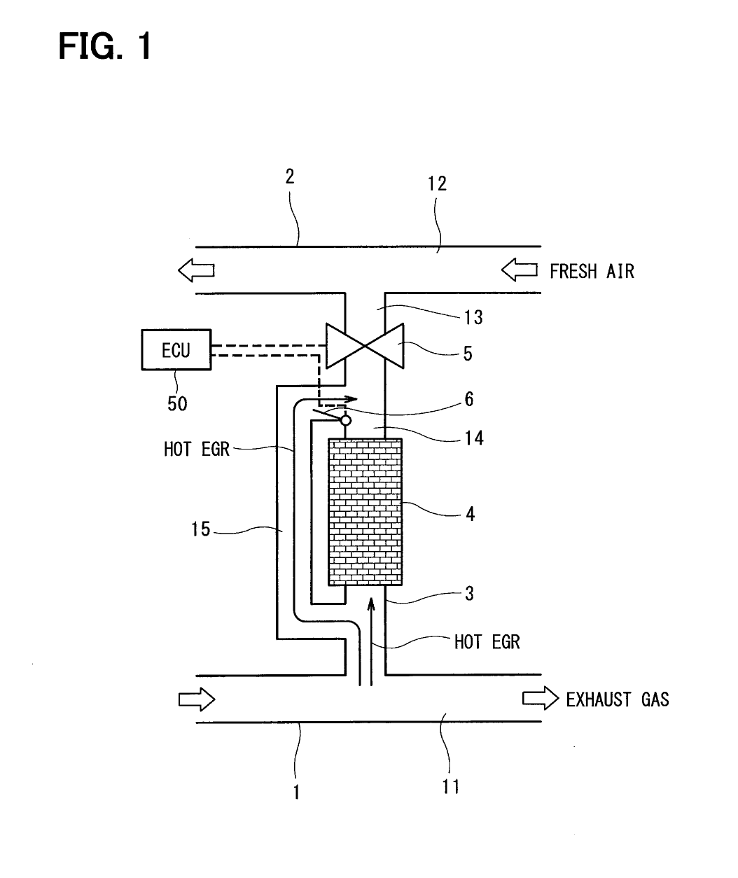

FIGS. 1 to 3 show an EGR system according to the first embodiment of the present disclosure. The EGR system employs an exhaust gas recirculation device.

A control device (engine control system) for an internal combustion engine according to the present embodiment includes, for example, a turbocharger, an EGR system, and a fuel supply device. The internal combustion engine is, for example, a diesel engine. The turbocharger pressure-charges intake air by utilizing pressure of exhaust gas emitted from the engine. The EGR system recycles (recirculates) EGR gas, which is a part of exhaust gas, from an exhaust pipe 1 of the engine into an intake pipe 2 of the engine. The fuel supply device supplies fuel, which is to be injected into each cylinder of the engine.

The fuel supply device is configured with a common-rail type fuel injection system, which is known as a fuel injection system for a diesel engine. The common-rail type fuel injection system includes a supply pump (high-pressure fuel pump), a common rail, and multiple injectors (fuel injection valves). The supply pump accommodates a feed pump (low-pressure fuel pump), which pumps low-pressure fuel from a fuel tank. The common rail receives high-pressure fuel from a discharge port of the supply pump. The injectors receive high-pressure fuel distributed through fuel outlets of the common rail, respectively. The common-rail type fuel injection system is configured to pressure-accumulate high-pressure fuel in the common rail and to supply the high-pressure fuel to the injectors. The injectors are caused to inject the high-pressure fuel into the cylinders of the engine, respectively.

The injectors are configured to inject fuel directly into the cylinders of the engine, respectively. The injectors form a direct-injection configuration to inject fuel to intake air, which flows into each cylinder. It is noted that, the system may employ injectors each configured to inject fuel into an intake port of each cylinder. The common rail is equipped with a common-rail pressure sensor to detect a common-rail pressure (fuel pressure), which corresponds to an injection pressure of fuel injected into the cylinders of the engine.

The EGR system is used as the exhaust gas recirculation device to recirculate EGR gas, which is a part of exhaust gas, from the exhaust passage of the internal combustion engine to the intake passage of the internal combustion engine. In the present example, the internal combustion engine is, for example, a diesel engine including multiple cylinders. Each of the multiple exhaust ports has a combustion-chamber-side end, which is equipped with an exhaust valve of the corresponding cylinder. The exhaust valve is configured to open and close an exhaust port opening, which opens to communicate with the combustion chamber of the corresponding cylinder. Each of the exhaust ports is connected with the exhaust pipe 1. Each of the multiple intake ports has a combustion-chamber-side end, which is equipped with an intake valve of the corresponding cylinder. The intake valve is configured to open and close an intake port opening, which opens to communicate with the combustion chamber of the corresponding cylinder. Each of the intake ports is connected with the intake pipe 2.

The exhaust pipe 1 is equipped with an exhaust manifold, a turbine for the turbocharger, a diesel particulate filter (DPF), a muffler, and/or the like. The exhaust manifold is connected to the exhaust port of each cylinder of the engine. More specifically, the exhaust manifold is connected to a downstream end of the exhaust port on the downstream side in an exhaust flow direction. The exhaust pipe 1 defines an exhaust passage 11 to conduct exhaust gas, which is exhausted from the combustion chamber of each cylinder, and to discharge the exhaust gas to the outside.

The intake pipe 2 is equipped with an air cleaner, the compressor of the turbocharger, an intercooler, a throttle valve, a surge tank, an intake manifold, and/or the like. The intake manifold is connected to the intake port of each cylinder of the engine. More specifically, the intake manifold is connected to an upstream end of the intake port on the upstream side in an intake flow direction. The intake pipe 2 defines an intake passage 12 to conduct intake gas, which is drawn into the combustion chamber of each cylinder. The engine is equipped with an exhaust recirculation pipe (EGR gas pipe) 3. The EGR gas pipe is equipped between a branch portion, at which the exhaust passage 11 branches from the exhaust pipe 1, and a merge portion, at which the intake passage 12 merges with the intake pipe 2.

The turbocharger includes the compressor and the turbine. The compressor is located at an intermediate portion of the intake pipe 2. The turbine is located at an intermediate portion of the exhaust pipe 1. The turbocharger functions as a supercharging device to cause the compressor to pressurize intake air, which flows through the intake pipe 2, and to supply the pressurized intake air into each cylinder of the engine. In the turbocharger, the turbine is rotated by flow of exhaust gas, and the compressor, which is connected with the turbine, is driven by the turbine. Thus, the compressor pressurizes intake air.

The throttle valve is configured as a valve element of an intake air throttle valve. This throttle valve is rotated and driven by an electric actuator, such as a motor. The actuator includes a throttle position sensor, which detects a throttle opening position. The throttle opening position corresponds to a rotation angle of the throttle valve. The opening position of the throttle valve is electronically controlled by an engine control unit (electronic control unit: ECU) 50. The present configuration enables to control the flow quantity (intake air amount) of intake air supplied into each cylinder of the engine.

The exhaust pipe 1 is located on the upstream side of the turbine of the turbocharger. The intake pipe 2 is located on the downstream side of the compressor of the turbocharger. The exhaust pipe 1 is connected with the intake pipe 2 through the EGR gas pipe 3. The EGR gas pipe 3 has an upstream end, which is connected with the exhaust pipe 1. The EGR gas pipe 3 has a downstream end, which is connected with the intake pipe 2. The EGR system having the above-described configuration is a high-pressure-loop (HPL) EGR system in which an output port of the exhaust passage 11 for the EGR gas is located on the upstream side of the turbine of the turbocharger.

Alternatively, the exhaust pipe 1 may be located on the downstream side of the turbine of the turbocharger and/or the DPF. In this case, the intake pipe 2 may be located on the upstream side of the compressor of the turbocharger. In addition, the exhaust pipe 1 is connected with the intake pipe 2 through the EGR gas pipe 3. In this case, the EGR gas pipe 3 has an upstream end, which is connected with the exhaust pipe 1. In addition, the EGR gas pipe 3 has a downstream end, which is connected with the intake pipe 2. The EGR system having the present configuration is a low-pressure-loop (LPL) EGR system in which an output port of the exhaust passage 11 for the EGR gas is located on the downstream side of the turbine of the turbocharger. The present embodiment may employ at least one of the HPL-EGR system and the LPL-EGR system.

The EGR gas pipe 3 is equipped with an EGR cooler 4, an EGR valve 5, and a bypass switching valve 6. The EGR gas pipe 3 defines an EGR gas (exhaust gas) recirculation passage (EGR passage) 13. The EGR passage recirculates EGR gas from the exhaust passage 11 in the exhaust pipe 1 to the intake passage 12 in the intake pipe 2. The EGR passage 13 includes an exhaust gas cooling passage 14 and a bypass passage 15. The exhaust gas cooling passage 14 receives EGR gas from the branch portion of the exhaust passage 11 and conducts the EGR gas through the EGR cooler 4 to the merge portion of the intake passage 12. The bypass passage 15 receives EGR gas from the branch portion of the exhaust passage 11 and to conducts the EGR gas to the merge portion of the intake passage 12 after bypassing the EGR cooler 4. The bypass passage 15 branches from an inlet of the exhaust gas cooling passage 14 at a branch portion and merges with an outlet of the exhaust gas cooling passage 14 at a merge portion.

The engine equipped with the EGR system has a cooling water circuit (cooling-water circulation passage). The cooling water circuit circulates cooling water (engine cooling water) and supplies the cooling water to the EGR cooler 4, which has a water-cooling configuration. The cooling water circuit includes cooling-water pipes, which are to circulate cooling water, and a water pump. One cooling-water pipe supplies cooling water from a water jacket of the engine to a cooling water inlet pipe (cooling-water pipe: not shown) of the EGR cooler 4. Another cooling-water pipe supplies cooling water from a cooling water outlet pipe (cooling-water pipe: not shown) of the EGR cooler 4 through a radiator to the engine water jacket. The water pump produces circulation of the cooling water in the cooling water circuit. The radiator is configured to implement heat exchange between cooling water and cooling wind (ambient air) thereby to produce cooling water in a predetermined temperature range, such as 60 to 80 degrees Celsius, and to return the cooling water to the water jacket.

The EGR cooler 4 functions as a water-cooling type heat exchanger (exhaust cooler) for cooling exhaust gas. The EGR cooler 4 implements heat exchange between cooling water, which is circulated and supplied from the engine water jacket, and EGR gas, thereby to cool the EGR gas. The EGR cooler 4 is located at an intermediate portion of the exhaust gas cooling passage 14. That is, the EGR cooler 4 is located between the branch portion, at which the bypass passage 15 braches from the exhaust gas cooling passage 14, and the merge portion, at which the bypass passage 15 merges with the exhaust gas cooling passage 14. The EGR cooler 4 includes multiple tubes, an exhaust distribution part (inlet side tank), and an exhaust collection part (discharge side tank). The multiple tubes communicate with the exhaust gas cooling passage 14. The exhaust distribution part distributes EGR gas, which flows from the outside, and conducts the distributed EGR gas into the multiple tubes. The exhaust collection part collects the EGR gas, which flows from the multiple tubes, and conducts the collected EGR gas to the outside. The exhaust distribution part and the exhaust collection part are connected to both ends of the multiple tubes, respectively.

The EGR valve 5 is located on the downstream side (intake pipe side) of the merge portion between the exhaust gas cooling passage 14 and the bypass passage 15. That is, the EGR valve 5 is located on the downstream side (intake pipe side) of the EGR cooler 4. This EGR valve is rotated and driven by an electric actuator, such as a motor. The electric actuator includes an EGR opening position sensor (EGR valve opening position detection unit). The EGR opening position sensor sends the ECU 50 an electric signal, which corresponds to an opening position of the EGR valve 5. The opening position of the EGR valve 5 corresponds to a rotation angle of the EGR valve 5. The opening position of the EGR valve 5 is electronically controlled by the ECU 50. The present configuration enables appropriately to conduct a suitable quantity of EGR gas correspondingly to an operating condition of the engine, together with fresh air after passing through the air cleaner. Thus, the EGR gas and the fresh air are conducted into each cylinder of the engine. In this way, the present configuration controls an EGR rate, which is a ratio of a total flow quantity (total recirculation quantity) of EGR gas to a total quantity of intake air supplied to each cylinder of the engine.

The bypass switching valve 6 functions as an EGR cooler bypass valve to switch among a bypass open mode, a bypass close mode, and a cooler close mode. In the bypass open mode, both the exhaust gas cooling passage 14 and the bypass passage 15 are opened. In the bypass close mode, the exhaust gas cooling passage 14 is opened, and the bypass passage 15 is closed. In the cooler close mode, the exhaust gas cooling passage 14 is closed, and the bypass passage 15 is opened. This bypass switching valve 6 is rotated and driven by an electric actuator, such as a motor. The electric actuator includes a bypass valve opening position sensor (bypass valve opening position detection unit). The bypass opening position sensor sends the ECU 50 an electric signal, which corresponds to an opening position of the bypass switching valve 6. The opening position of the bypass switching valve 6 corresponds to a rotation angle of the bypass switching valve 6. The opening position of the bypass switching valve 6 is electronically controlled by the ECU 50. The present configuration enables to control a flow quantity of EGR gas, which passes though the EGR cooler 4, and a flow quantity of EGR gas, which bypasses the EGR cooler 4 appropriately.

The ECU 50 includes a microcomputer having a generally known configuration. The microcomputer includes functional elements configured to function as a CPU, a memory device, such as a ROM, a RAM, and/or an EEPROM), an input circuit (input unit), and/or an output circuit (output unit). The microcomputer further includes functional elements configured to function as a power supply circuit, a timer circuit, a pump driver circuit, a pressure reduction valve driver circuit, an injector driver circuit, and/or the like. The input unit of the microcomputer is configured to receive sensor output signals (electric signals) from various sensors. The sensor output signals are A/D converted through an A/D conversion circuit in advance and received by the input unit. The sensor output signals may include, for example, a sensor output signal (pressure detection value) sent from a common rail pressure sensor, which is mounted to the common rail.

The input portion of the microcomputer is connected with various sensors such as an air flow sensor, a crank angle sensor, the EGR opening position sensor, the bypass opening position sensor, an accelerator position sensor, a throttle position sensor, a charging pressure (intake air pressure) sensor, a cooling water temperature sensor, an exhaust gas sensor, and/or the like. The exhaust gas sensor may include an exhaust gas temperature sensor, an air-fuel ratio sensor, and/or an oxygen concentration sensor. The various sensors may function as an operation state detection unit configured to detect an operation state of the engine. The accelerator position sensor may function as an engine load detection unit configured to detect a depression quantity of the accelerator by a driver, thereby to detect an engine load. The throttle position sensor may function as the engine load detection unit.

The ECU 50 implements a passage switching control to avoid condensate water from accumulating in the EGR cooler 4, thereby to avoid corrosion of the EGR cooler 4. Specifically, the ECU 50 changes a passage mode of the EGR system, that is, the switching position (control position) of the bypass switching valve 6. In the passage switching control, the ECU 50 sets the passage mode at one of the bypass open mode, the bypass open mode, and the cooler close mode. In the bypass open mode, both the exhaust gas cooling passage 14 and the bypass passage 15 are opened. In the bypass close mode, the exhaust gas cooling passage 14 is opened, and the bypass passage 15 is closed. In the cooler close mode, the exhaust gas cooling passage 14 is closed, and the bypass passage 15 is opened. The passage switching control is implemented according to the engine operation condition.

### Operation Effect of First Embodiment

Subsequently, an operation effect of the EGR system according to the present embodiment will be briefly described with reference to FIG. 1 to FIG. 3.

The ECU 50 is configured to acquire (receive) various sensor output signals first in response to activation (IG-ON) of the ignition switch. The various sensor output signals are needed to calculate the engine operation condition (engine information) and/or the operation state. The ECU 50 is further configured to control the motor of the EGR valve 5 and the motor of the bypass switching valve 6 electronically according to an engine operation condition and/or a program, which is stored in the ROM.

The ECU 50 calculates (determines) a control target value (target EGR rate) according to the engine operation condition. The engine operation condition may include, for example, a quantity of fresh air, an engine speed (NE), and/or the engine load. The quantity of fresh air is detected according to the sensor output signal (AFM signal) sent from the air flow sensor. The engine speed (NE) is detected according to an NE pulse signal sent from the crank angle sensor. The engine load is detected according to the sensor output signal sent from the accelerator position sensor and/or the throttle position sensor. The ECU 50 further feedback controls the opening position of the throttle valve and/or the opening position of the EGR valve 5 such that a deviation of the EGR rate, which is detected according to the sensor output signal of the EGR opening position sensor, relative to the target EGR rate.

(1) Engine Stop State (EGR Cut State)

The ECU 50 implements EGR cut to terminate supply of EGR gas to fresh air in order to stabilize an engine combustion state, when the engine is in a predetermined operating range. The ECU 50 may implement the EGR cut when the engine is in an operating range in which, for example, the engine load is low, and the engine rotation speed is low. Alternatively, the ECU 50 implements the EGR cut to terminate supply of EGR gas to fresh air in order to avoid power loss of the engine, which is caused by supplying EGR gas into each cylinder of the engine, when a driver depresses the accelerator pedal to produce an engine power at maximum. In such a case, the EGR valve 5 is in a full close state. Thus, the EGR system is de-activated to be in an EGR non-active state.

(2) Engine Operating State (EGR Supply State)

The ECU 50 computes a control target value, such as the target EGR rate and/or the target EGR opening position, when a driver depresses the accelerator pedal and when the operating state enters a predetermined engine operating range. In the predetermined engine operating range, for example, the engine load is a low engine load or a middle engine load, and the engine rotation speed is a low engine rotation speed or a middle engine rotation speed. The control target value is determined correspondingly to the engine load and/or the engine rotation speed in the operating range. At this time, the ECU 50 operates the EGR valve 5, such that the opening position of the EGR valve 5 becomes greater than a predetermined opening position. Presently, the EGR valve 5 is in a valve-open state, and the EGR system is in an operating state (EGR operation). The ECU 50 controls the opening position of the throttle valve arbitrarily. In this way, the opening position of the EGR valve 5 is controlled, and the opening position of the EGR valve 5 is changed correspondingly to the engine operation condition. Thus, a quantity of EGR gas supply (mixing quantity) relative to a quantity of clean fresh air, which has passed through the air cleaner, is controlled. Thus, EGR gas is recirculated into each cylinder of the engine. In this way, toxic substance, such as nitrogen oxide (NOx), contained in exhaust gas is reduced.

The ECU 50 controls the motor and/or a negative-pressure actuator, which rotates the bypass switching valve 6, when the engine is in a normal operation state, and/or when the temperature of cooling water is greater than or equal to a predetermined value, such as 60 degrees Celsius. Thus, the passage mode of the EGR system enters a cool EGR gas mode (bypass close mode). Thus, the switching position (control position) of the bypass switching valve 6 is set at the bypass close mode.

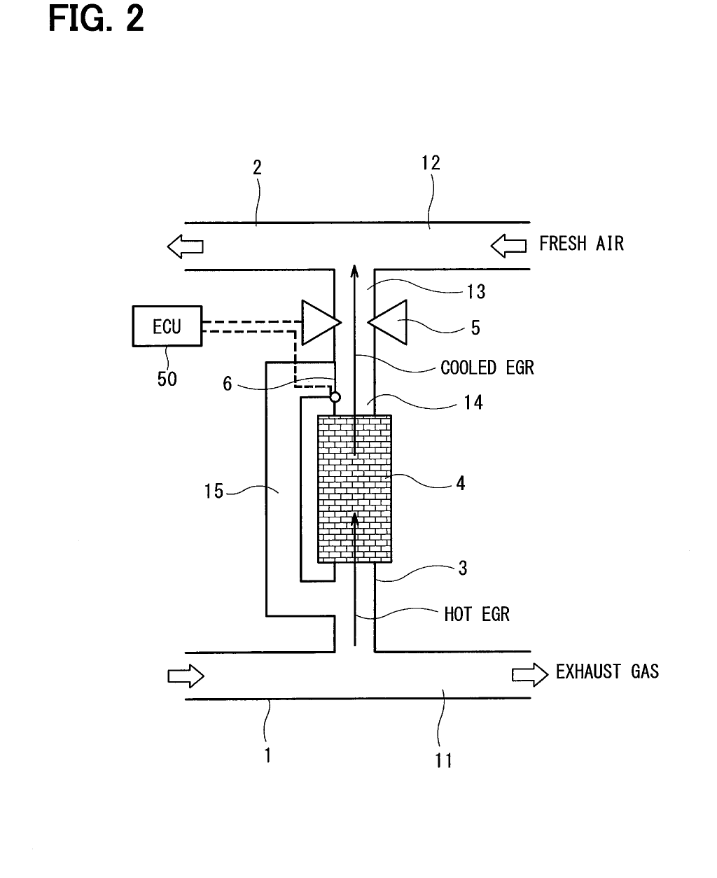

As shown in FIG. 2, in the bypass close mode, the exhaust gas cooling passage 14 is opened, and the bypass passage 15 is closed (full close state). Therefore, cooled EGR gas is recirculated into the intake passage 12 after passing through the branch portion of the exhaust passage 11, the EGR passage 13, the exhaust gas cooling passage 14 including the EGR cooler 4, and the EGR valve 5. EGR gas flows from the branch portion of the exhaust passage 11 into the EGR passage 13, and the EGR gas exchanges heat with cooling water, which passes through the tubes of the EGR cooler 4. Thus, the EGR gas is cooled.

In the present configuration, low temperature (cooled) EGR gas, which is low in temperature and small in volume, is mixed with fresh air. Therefore, combustion temperature of the engine can be effectively reduced, and emission of NOx can be effectively reduced, without reduction in engine output. When hot EGR gas, which is high in temperature, flows into the EGR cooler 4, the hot EGR gas is cooled by cooling water, which is circulated through the EGR cooler 4. Consequently, condensate water may be generated. At this time, the EGR valve 5 opens, and therefore, the condensate water flows into the intake passage 12 together with cooled EGR gas, without accumulating in the EGR cooler 4. Thus, the condensate water and cooled EGR gas are together drawn into the cylinder when the intake valve opens.

The ECU 50 controls the motor and/or a negative-pressure actuator, which rotates the bypass switching valve 6, in a cold season, such as winter, and/or when the temperature of cooling water is less than or equal to a predetermined value, such as 60 degrees Celsius. Thus, the passage mode of the EGR system enters a hot EGR gas mode (cooler close mode). Thus, the switching position (control position) of the bypass switching valve 6 is set at the cooler close mode.

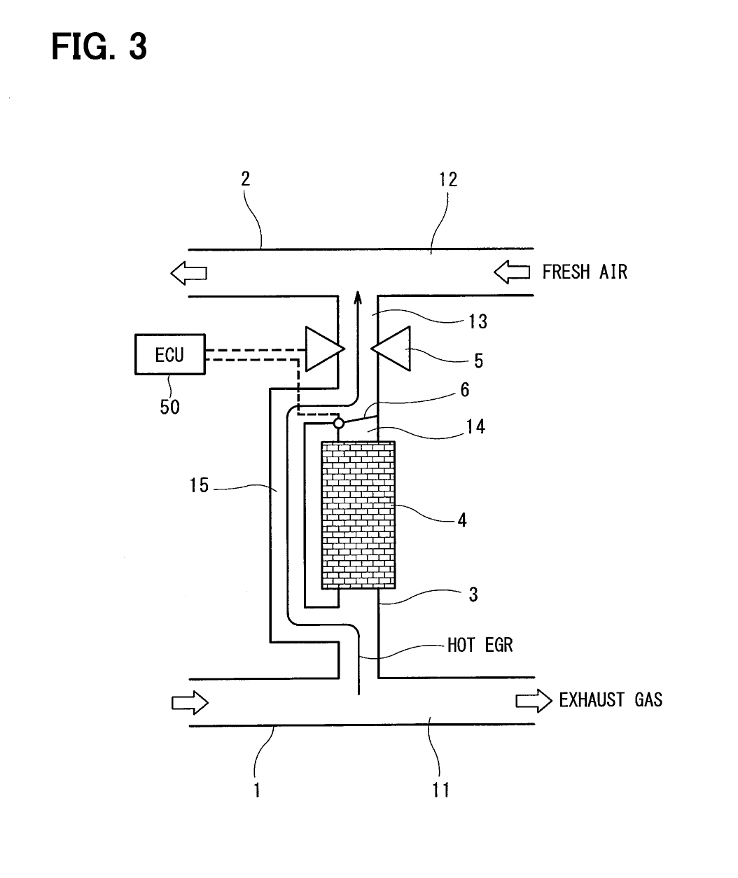

As shown in FIG. 3, in the cooler close mode, the exhaust gas cooling passage 14 is closed (full close state), and the bypass passage 15 is opened. Therefore, hot EGR gas is recirculated into the intake passage 12 after passing through the branch portion of the exhaust passage 11, the EGR passage 13, the bypass passage 15, and the EGR valve 5. The present configuration enables to warm up the engine and to enhance the ignition performance in each cylinder of the engine, thereby to restrict emission of white smoke. In the present mode, hot EGR gas passes through the bypass passage 15 without flowing into the EGR cooler 4. Therefore, condensate water may not be produced.

### Operation Effect of First Embodiment

As described above, the EGR system of the present embodiment controls the motor and/or the negative-pressure actuator, which rotates the bypass switching valve 6, to set the passage mode of the EGR system in the bypass open mode, when the engine is in operation and when the EGR valve 5 is in the full close state to terminate the operation of the EGR system (EGR non-active state). Thus, the switching position (control position) of the bypass switching valve 6 is set at the bypass open mode.

As shown in FIG. 1, in the bypass open mode, both the exhaust gas cooling passage 14 and the bypass passage 15 are opened. Therefore, the passage on the downstream side of the EGR cooler 4 communicates with the passage on the upstream side of the EGR cooler 4 through the bypass passage 15. At this time, EGR gas flow, which passes through the tubes of the EGR cooler 4, causes a large pressure loss, and EGR gas flow, which passes through the bypass passage 15, causes a small pressure loss. The present configuration enables to pass EGR gas flow through the bypass passage 15 thereby to reduce a pressure difference between a pressure on the downstream side of the EGR cooler 4 and a pressure on the upstream side of the EGR cooler 4. Therefore, a quantity of EGR gas passing through the EGR cooler 4 can be reduced.

For example, operation of the exhaust valve may cause pressure pulsation of exhaust gas (pressure wave of exhaust pulsation) to cause exhaust gas to flow in and out the EGR passage 13 from the exhaust passage 11. Even in such a state, condensate water can be restricted from occurring in the EGR cooler 4. In this way, generation of condensate water in the EGR cooler 4 can be effectively avoided. Therefore, a quantity of condensate water, which accumulates in the EGR cooler 4 and the EGR passage 13, can be reduced. The present configuration enables to avoid corrosion of the EGR gas pipe 3, the EGR cooler 4, and/or the like. In the present configuration, condensate water generated in the EGR cooler 4 may hardly accumulate in the EGR cooler 4 and/or the EGR passage 13. Therefore, even when condensate water contains a strong acid component, the EGR gas pipe 3, the EGR cooler 4, and/or the like can be protected from corrosion, thereby to avoid a serious fault such as perforation.

The present configuration enables to reduce generation of condensate water in the EGR cooler 4. Therefore, when the EGR valve 5 is activated and opened or when leakage occurs in the EGR valve 5, condensate water may hardly flow toward the intake passage. Therefore, the valve of the intake air system, such as the throttle valve, can be protected from icing. The present configuration restricts a large quantity of condensate water from flowing into the cylinders of the engine. Therefore, the present configuration maintains an engine combustion state and avoids misfire in the engine. The present configuration enables to reduce generation of condensate water in the EGR cooler 4. Therefore, when the EGR valve 5 is activated and opened or when leakage occurs in the EGR valve 5, condensate water may hardly flow toward the intake passage. Therefore, the valve of the intake air system, such as the throttle valve, can be protected from icing. The present configuration restricts a large quantity of condensate water from flowing into the cylinders of the engine, when the EGR system is in operation, that is, when the EGR valve 5 is in the valve-open state. Therefore, the present configuration restricts the engine from causing misfire and stalling.

(Modification)

According to the present embodiment, the exhaust gas recirculation device of the present disclosure is employed in the HPL-EGR system or the LPL-EGR system, which recirculates a part of exhaust gas as EGR gas to the intake passage of the internal combustion engine. It is noted that, one of the HPL-EGR system and the LPL-EGR system may not be provided in the internal combustion engine.

The charging device is not limited to the turbocharger and may be a supercharger or an electric compressor. The charging device may not be provided in the internal combustion engine.

The internal combustion engine may be a gasoline engine. The internal combustion engine may be a multi-cylinder engine and may be a single-cylinder engine.

In the present embodiment, the electric actuator, which includes the motor, is employed as the actuator to manipulate the EGR valve 5. It is noted that, the actuator, which manipulates the EGR valve 5, may be a negative-pressure actuator, which is manipulated by a negative pressure caused by an electric vacuum pump and conducted through a vacuum control valve. The actuator, which manipulates the EGR valve 5, may be a linear solenoid device (solenoid actuator), which is equipped with an electromagnet including a coil.

In the present embodiment, the electric actuator, which includes the motor, is employed as the actuator to manipulate the bypass switching valve 6. It is noted that, the actuator, which manipulates the bypass switching valve 6, may be a negative-pressure actuator, which is manipulated by a negative pressure caused by an electric vacuum pump and conducted through a vacuum control valve. The actuator, which manipulates the bypass switching valve 6, may be a linear solenoid device (solenoid actuator), which is equipped with an electromagnet including a coil.

In the present embodiment, cooling water, which circulates through the cooling water circuit to cool the engine, is used as cooling water to cool EGR gas. It is noted that, cooling water, which circulates through a cooling water circuit for exclusive use to cool EGR gas, may be used as cooling water to cool EGR gas. In this case, the cooling water circuit may include cooling-water pipes and a water pump. One cooling water pipe circulates cooling water to supply the cooling water from a reserve tank to the cooling water inlet pipe of the EGR cooler 4. Another cooling-water pipe circulates cooling water to supply the cooling water from a cooling water outlet pipe of the EGR cooler 4 to the reserve tank through the radiator. The water pump produces the circulation of cooling water in the cooling water circuit.

The exhaust gas recirculation device according to the present disclosure includes the exhaust gas recirculation passage configured to recirculate a part of exhaust gas from the exhaust passage of the internal combustion engine to the intake passage. The exhaust gas recirculation device further includes the exhaust gas cooling passage including the EGR cooler, which is configured to cool exhaust gas passing through the exhaust gas recirculation passage. The exhaust gas recirculation device further includes the bypass passage configured to branch a flow of exhaust gas, which passes through the exhaust gas recirculation passage, at an upstream of the exhaust gas cooling passage and to bypass the EGR cooler to conduct the flow of exhaust gas toward a downstream of the exhaust gas cooling passage. The exhaust gas recirculation device further includes the bypass switching valve located at the merge portion between the exhaust gas cooling passage and the bypass passage or located at the bypass passage. The bypass switching valve is configured to switch among the bypass open mode to open both the exhaust gas cooling passage and the bypass passage, the bypass close mode to open the exhaust gas cooling passage and to close the bypass passage, and the cooler close mode to close the exhaust gas cooling passage and to open the bypass passage.

The configuration according to the disclosure sets the bypass switching valve at the bypass open mode when the EGR valve stops its operation, that is, when the EGR system is not in the activated state, that is, when the EGR system is in the de-activated state. In this way, the bypass passage communicates the passage on the upstream side of the EGR cooler with the passage on the downstream side of the EGR cooler. In the present state, a pressure loss caused in exhaust gas flow passing through the EGR cooler becomes large, and a pressure loss of exhaust gas flow passing through the bypass passage becomes small. In the present configuration, the bypass passage enables to reduce a pressure difference between a pressure on the upstream side of the EGR cooler and a pressure on the downstream side of the EGR cooler. Therefore, a quantity of exhaust gas, which flows into the EGR cooler, can be reduced. Thus, the present configuration enables to reduce generation of condensate water in the EGR cooler. That is, the present configuration enables to restrict condensate water from generating in the EGR cooler efficiently, thereby to avoid corrosion of the EGR cooler and/or the like.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. An exhaust gas recirculation device comprising:
an exhaust gas recirculation passage configured to recirculate a part of exhaust gas from an exhaust passage of an internal combustion engine to an intake passage of the internal combustion engine;
an EGR valve configured to control an opening of the exhaust gas recirculation passage;
an exhaust gas cooling passage including an EGR cooler, which is closer to the exhaust passage than the EGR valve;
a bypass passage configured
to branch a flow of exhaust gas, which passes through the exhaust gas recirculation passage, at an upstream of the exhaust gas cooling passage and
to bypass the EGR cooler and to conduct the flow of exhaust gas toward a downstream of the exhaust gas cooling passage; and
a bypass switching valve located at a merge portion between the exhaust gas cooling passage and the bypass passage or located at the bypass passage, the bypass switching valve configured to switch among
a bypass open mode to open both the exhaust gas cooling passage and the bypass passage,
a bypass close mode to open the exhaust gas cooling passage and to close the bypass passage, and
a cooler close mode to close the exhaust gas cooling passage and to open the bypass passage, wherein
the bypass switching valve is configured to be set at the bypass open mode when the EGR valve is in a full close state.

2. The exhaust gas recirculation device according to claim 1, wherein the bypass switching valve is set at the bypass close mode when the EGR valve opens.

3. The exhaust gas recirculation device according to claim 1, wherein the bypass switching valve is set at the cooler close mode when the EGR valve opens.

4. The exhaust gas recirculation device according to claim 1, wherein the EGR cooler is configured to function as a water-cooled exhaust gas cooler to exchange heat of exhaust gas, which flows through the exhaust gas cooling passage, with heat of cooling water to cool the exhaust gas.
